(19) United States
(12) Patent Application Publication
(10) Pub. No.: US 2015/0268913 A1
(43) Pub. Date: Sep. 24, 2015

(54) IMAGE PROCESSING SYSTEM, IMAGE PROCESSING DEVICE, AND PROCESSING CONTROL DEVICE

(71) Applicant: FUJI XEROX CO., LTD., Tokyo (JP)

(72) Inventors: Shintaro ADACHI, Kanagawa (JP); Shigeru OKADA, Kanagawa (JP); Katsuya KOYANAGI, Kanagawa (JP); Minoru SODEURA, Kanagawa (JP); Shinji HANAOKA, Kanagawa (JP); Hiroyuki KISHIMOTO, Kanagawa (JP)

(21) Appl. No.: 14/631,360

(22) Filed: Feb. 25, 2015

(30) Foreign Application Priority Data
Mar. 19, 2014 (JP) 2014-056594

(51) Int. Cl. G06F 3/12

(52) U.S. Cl. CPC G06F 3/1297

(57) ABSTRACT

An image processing system includes a processing control device and an image processing device. The processing control device includes a request transmitting unit that transmits a processing request for requesting execution of image processing to the image processing device, and a result receiving unit that receives processing result information including identification information of an image of a processing result corresponding to the processing request and a compressed image obtained by compressing the image of the processing result, from the image processing device. The image processing device includes an execution controller that determines whether or not an image associated with the identification information included in the processing request is stored in a processing result memory, and causes an executing unit to execute image processing on the image stored in the memory if stored, or on an image obtained by decompressing a compressed image included in the processing request if not stored.

### CROSS-REFERENCE TO RELATED APPLICATIONS

This application is based on and claims priority under 35 USC 119 from Japanese Patent Application No. 2014-056594 filed Mar. 19, 2014.

### BACKGROUND

(i) Technical Field

The present invention relates to an image processing system, an image processing device, and a processing control device.

(ii) Related Art

In general, an auxiliary system that allows image processing to be executed at high speed is added to a system having information processing functions, such as a general-purpose computer or a digital multifunction machine (that is, a multifunction machine having functions of a printer, a scanner, a copier, a facsimile, and so forth), to improve the functions. Such an auxiliary system is provided as, for example, a graphic accelerator that is connected with a processor of a main system through a bus, or a computer for image processing that is connected with the main system through a communication path, such as a universal serial bus (USB) or a local area network (LAN).

With such a system, if the data amount of an image of a processing target is large, for example, because the image has high resolution, insufficiency may arise in a communication band between the main system and the auxiliary system. As a countermeasure to this, there is known a method of avoiding the insufficiency of the band by applying data compression to an image that is exchanged between the main system and the auxiliary system. A compression method of an image in this case frequently employs a lossy compression method of, for example, joint photographic experts group (JPEG) for increasing the compression ratio.

Image data may be exchanged between the main system and the auxiliary system many times for a series of processing on a single image. In this case, the image quality of the image may be markedly degraded due to lossy compression executed many times.

### SUMMARY

According to an aspect of the invention, there is provided an image processing system including a processing control device; and an image processing device. The processing control device includes a request transmitting unit that, in accordance with a processing procedure including at least one image processing, transmits a processing request for requesting execution of each image processing in the processing procedure, to the image processing device; and a result receiving unit that receives processing result information including identification information of an image of a processing result corresponding to the processing request and a compressed image obtained by compressing the image of the processing result, from the image processing device. If the request transmitting unit requests second image processing on an image of a processing result of first image processing in the processing procedure, the request transmitting unit transmits a processing request including information for specifying the second image processing, as well as identification information and a compressed image included in processing result information received by the result receiving unit from the image processing device in response to a processing request of the first image processing, to the image processing device. The image processing device includes a decompressing unit that decompresses a compressed image; a request receiving unit that receives a processing request from the processing control device; an executing unit that generates an image of a processing result by executing image processing specified in the processing request on an image corresponding to identification information included in the processing request received by the request receiving unit; a processing result memory that stores the image of the processing result in association with identification information of the image of the processing result; a compressing unit that generates a compressed image of the processing result by executing compression processing on the image of the processing result; a result returning unit that returns processing result information including the identification information of the image of the processing result and the compressed image of the processing result, to the processing control device; and an execution controller that determines whether or not an image associated with the identification information included in the processing request received from the processing control device is stored in the processing result memory, and causes the executing unit to execute image processing on the image stored in the processing result memory if the image is stored, or on an image obtained by causing the decompressing unit to decompress a compressed image included in the processing request if the image is not stored.

### BRIEF DESCRIPTION OF THE DRAWINGS

An exemplary embodiment of the present invention will be described in detail based on the following figures, wherein:

FIG. 1 is an illustration showing an example of a system to which control according to an exemplary embodiment is applied;

FIG. 2 is an illustration for describing a specific example of a flow in which a series of processing is executed by the system in FIG. 1;

FIG. 3 is an illustration showing an example of a system configuration according to the exemplary embodiment;

FIG. 4 is an illustration showing an example of a processing procedure of a target image determining unit;

FIG. 5 is an illustration showing an example of a processing procedure of a memory controller;

FIG. 6 is an illustration for describing a scene in a flow of specific processing in the system according to the exemplary embodiment;

FIG. 7 is an illustration for describing another scene in the flow of specific processing in the system according to the exemplary embodiment;

FIG. 8 is an illustration for describing still another scene in the flow of specific processing in the system according to the exemplary embodiment;

FIG. 9 is an illustration showing an example of a procedure by the memory controller for determining whether or not a processing result image is stored; and

FIG. 10 is an illustration showing another example of a processing procedure of the memory controller.

### DETAILED DESCRIPTION

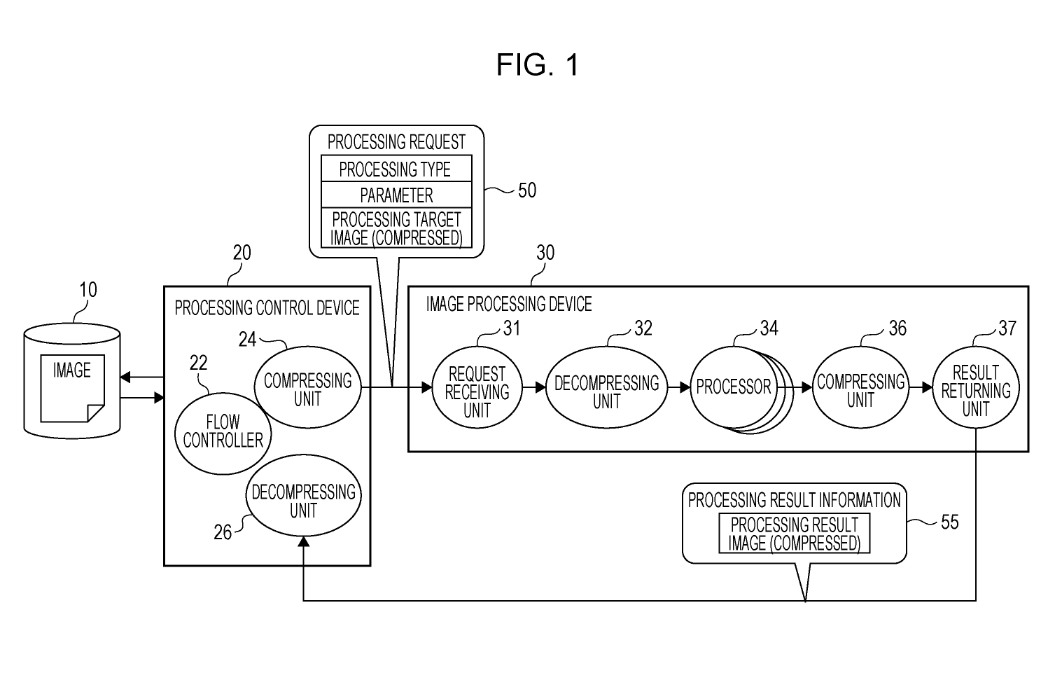

Briefly described first is a configuration example of an image processing system to which a method of an exemplary embodiment is applied, with reference to FIG. 1.

The image processing system shown in FIG. 1 includes a storage device 10, a processing control device 20, and an image processing device 30. If this system is provided as a single computer, the storage device 10 is a secondary memory such as a hard disk, and the processing control device 20 includes hardware, such as a central processing unit (CPU) and a memory of the computer, and software executed by the CPU. In this case, the image processing device 30 is configured as a graphic accelerator or the like that is connected with the CPU of the processing control device 20 through a bus, such as a peripheral component interconnect (PCI) bus. Of course, this is merely an example. The storage device 10, the processing control device 20, and the image processing device 30 may be executed as different computers, and may be connected through a data communication network such as LAN and hence formed as a system. The method of this exemplary embodiment does not particularly depend on the form of communication connection between the processing control device 20 and the image processing device 30.

The storage device 10 is a device that stores data, such as image data of a processing target, and image data of processing result. Image data to be stored in the storage device 10 is generated by various devices inside and outside the processing control device 20, and, for example, the image data is stored in the storage device 10 through the processing control device 20. For example, image data generated when a paper document is read by a scanner under control of the processing control device 20 may be stored in the storage device 10, and image data indicative of a print document generated by an external editing device may be transmitted to the processing control device 20 through a network and may be stored in the storage device 10. Also, the processing control device 20 may execute processing on image data read from the storage device 10 while using the image processing device 30, and may store the image data obtained as the result of the processing, in the storage device 10. The format of image data is not particularly limited.

Also, data to be stored in the storage device 10 may be document data containing image data therein. For example, the data to be stored may be portable document format (PDF) data containing an image object expressed by a format such as JPEG or bitmap. Also, the data to be stored may be print data described in a page description language such as PostScript (registered trademark).

The image processing device 30 has a function of executing at least one image processing. Image processing executable by the image processing device 30 includes, for example, binarization of an image, skew (tilt) correction, color dropout (processing of deleting an image pertaining to at least one predetermined color range from an image), enlargement, reduction, etc. However, these are merely examples. The image processing device 30 does not have to execute all the exemplified image processing, and may have a function of executing image processing other than the exemplified image processing.

The image processing device 30 executes aforementioned at least one image processing typically by a hardware circuit. For example, the image processing device 30 may have an individual processing circuit for each of image processing. Also, the image processing device 30 may be configured by using a programmable circuit, such as a field-programmable gate array (FPGA) or a dynamically reconfigurable processor (DRP). The programmable circuit may execute plural types of image processing by timely changing inside circuit configurations. Also, the image processing device 30 may provide at least one image processing by software processing.

The image processing device 30 includes a request receiving unit 31, a decompressing unit 32, at least one processor 34, a compressing unit 36, and a result returning unit 37.

The request receiving unit 31 is a functional module that receives a processing request 50 from the processing control device 20. The processing request 50 includes information for specifying a processing type of image processing requested by the processing control device 20 (for example, command name), a parameter of the image processing (if required), and compressed data of an image being a target of the image processing (referred to as “processing target image”). The parameter of the image processing includes, for example, magnification etc., for enlargement and reduction processing.

The decompressing unit 32 is a functional module that decompresses the compressed image data. The decompressing unit 32 reproduces a raw image (for example, in the bitmap form) of the processing target image by decompressing the compressed processing target image included in the processing request 50.

The individual processor 34 is a functional module that executes corresponding image processing. The compressed data of the processing target image included in the processing request 50 is decompressed by the decompressing unit 32, and then processed by the processor 34 corresponding to the processing type in the processing request 50.

The compressing unit 36 compresses an image of the processing result output from the processor 34 (hereinafter, referred to as “processing result image”). The result returning unit 37 returns processing result information 55 as a response to the processing request 50 to the processing control device 20. The processing result information 55 includes compressed data of the processing result image output from the compressing unit 36.

The processing control device 20 receives a processing instruction for image data or document data in the storage device 10 from an outside user etc., and controls execution of a series of processing according to the instruction. In the series of processing, image data is transmitted to the image processing device 30 to request the image processing device 30 for at least one specific image processing corresponding to the image processing device 30. The image data transmitted at this time is in a compressed state (the compressed data of the processing target image in the processing request 50 in the drawing).

The processing control device 20 includes a flow controller 22, a compressing unit 24, and a decompressing unit 26. The flow controller 22 is a functional module that controls a flow of a series of processing in accordance with an instruction from the outside (hereinafter, referred to as “processing flow”). The instruction includes, for example, instruction information that defines a processing flow of executing processing A on image data of a target, executing processing B on the processing result, and further executing processing C on the processing result. The processing flow defined by the instruction information is not limited to a one-way flow as described in the above example. For example, processing may be branched in the middle and plural processing results corresponding to the individual branches may be generated, or processing results at the individual branches may be finally integrated and one processing result may be generated. Also, image data or document data being a target of a series of processing is not limited to single piece of data. There may be a processing flow of executing some sets of processing on plural inputs (images, documents, or the like), and integrating respective processing results, to generate a final processing result.

The flow controller 22 controls a flow of a series of processing on at least one image or a document including an image in accordance with instruction information that defines such a processing flow. Individual processing configuring a processing flow (hereinafter, referred to as “unit processing”) may include processing to be executed by the processing control device 20 and processing to be executed by the image processing device 30. Also, a processing flow may occasionally include processing to be executed by an external device allowed to have communication with the processing control device 20 through a LAN, the Internet, or the like.

When the flow controller 22 reaches unit processing executed by the image processing device 30 while the flow controller 22 successively executes processing in accordance with a processing flow indicated by instruction information, the flow controller 22 generates a processing request 50 for requesting execution of the unit processing, and transmits the processing request 50 to the image processing device 30. The processing request 50 includes compressed data of a processing target image being a target of the requested unit processing as described above. If the processing target image is in a format of a raw image (bitmap format or the like), the processing target image is compressed by the compressing unit 24 and then arranged in the processing request 50. When processing result information for the processing request 50 is returned from the image processing device 30, the processing progresses to the next unit processing in the processing flow by using the compressed data of the processing result image included in the processing result information. If the next unit processing is processing to be executed by an application in the processing control device 20, the compressed data is decompressed by the decompressing unit 26, and image data obtained as the result of the decompression is given to the application as the processing target image. If the processing result by the application is an image and the processing flow defines that the image processing device 30 executes still another image processing on the image of the processing result, the flow controller 22 causes the compressing unit 24 to compresses the image of the processing result, generates the processing request 50 including the image of the compression result as a processing target, and transmits the processing request 50 to the image processing device 30.

The unit processing that is executed in the processing control device 20 is not limited to a type of obtaining an image as a processing result. For example, the processing control device 20 may execute various processing, such as recognition processing of recognizing a machine readable code such as a barcode or a character from the image, processing of sorting the image of the processing result, processing of creating a document or an e-mail having arranged therein the image of the processing result, or processing of storing the image of the processing result in a file system. The processing control device 20 takes charge of, for example, various processing that is not appropriate for processing in the hardware circuit.

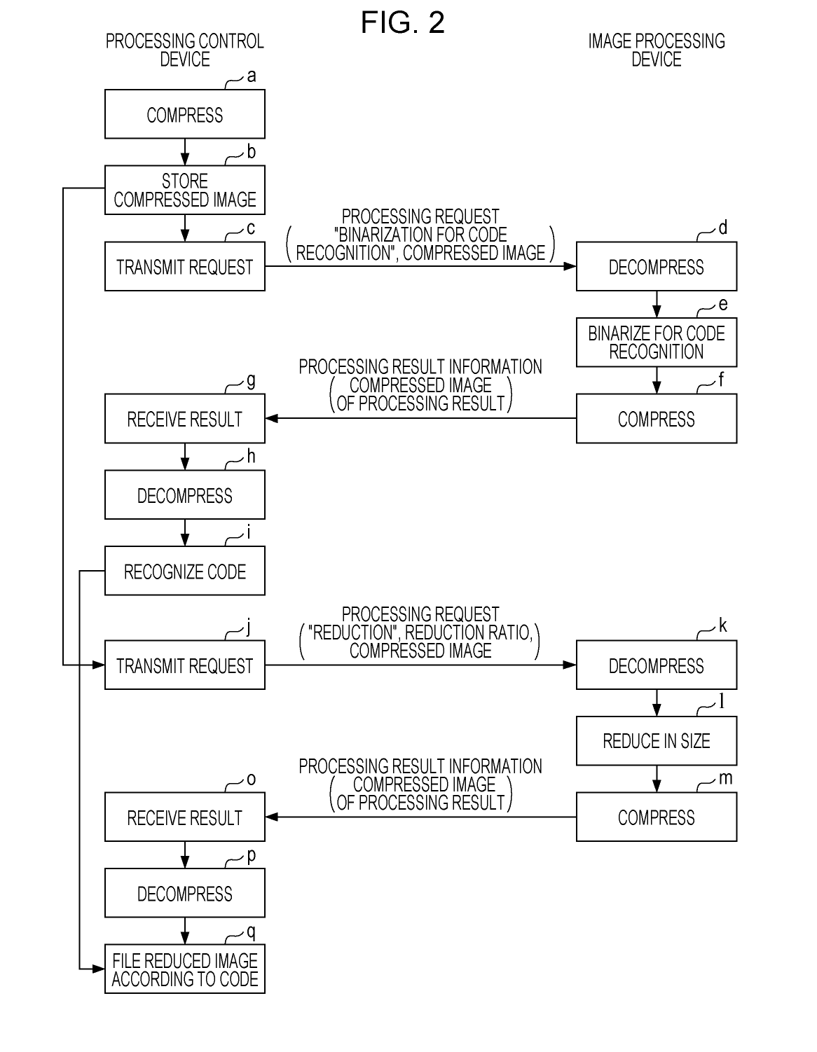

An example of the processing flow in the system in FIG. 1 is described with reference to FIG. 2. This processing flow is a series of processing of recognizing a barcode included in a document image, reducing the size of the document image into a predetermined size, applying a file name including a document name indicated by the barcode to the reduced image, and storing the reduced image in a file system.

In this processing flow, the flow controller 22 of the processing control device 20 recognizes that first unit processing in a processing flow defined by a processing instruction is “binarization for code recognition” for a document image of a processing target, and the image processing device 30 takes charge of “the binarization for code recognition.” Based on the recognition, the flow controller 22 reads the document image of the processing target from the storage device 10, and (a) causes the compressing unit 24 to compress the document image. (b) Also, the flow controller 22 recognizes that reduction processing of the document image is included in the processing flow, and stores a compressed image generated by the compressing unit 24 in a memory or the like for preparation of the reduction processing. (c) Also, the flow controller 22 generates a processing request including the compressed image as data of the processing target image and designating the processing of “the binarization for barcode recognition” as a processing type, and transmits the created processing request to the image processing device 30.

In the image processing device 30, (d) the request receiving unit 31 receives the processing request, and the decompressing unit 32 decompresses the compressed image in the processing request. (e) Then, image data of the decompression result output from the decompressing unit 32 is supplied to the processor 34 that executes “the binarization for barcode recognition” corresponding to the processing type designated in the processing request, and the processor 34 executes “the binarization for barcode recognition” on the image. “The binarization for barcode recognition” is processing of binarizing the document image into a form suitable for barcode recognition. Then, (f) the compressing unit 36 compresses the image of the binarization result output by the processor 34, and the result returning unit 37 returns processing result information including the compressed image to the processing control device 20.

(g) The processing control device 20 receives the processing result information. The flow controller 22 recognizes that unit processing to be executed next on the processing result of “the binarization processing for barcode recognition” in the processing flow is barcode recognition from the image of the processing result. (h) To execute the barcode recognition, the flow controller 22 causes the decompressing unit 26 to decompress the compressed image in the processing result information, (i) the flow controller 22 gives the image output from the decompressing unit 26 to a barcode recognition program that is executed by the CPU of the processing control device 20, and causes the program to execute the barcode recognition. The barcode recognition program recognizes a barcode included in the image, and obtains the content of data indicated by the barcode. In this case, for example, it is assumed that the barcode indicates the document name of the document image.

The flow controller 22 recognizes that unit processing to be executed next by using the recognition result of the barcode recognition is processing of applying a file name including the data (document name) of the recognition result to the separately generated reduced image of the document image and filing the reduced image (processing (q), described later). With this recognition, the flow controller 22 temporarily stores the barcode recognition result in a memory or the like until the reduction processing of the document image is completed.

Also, the flow controller 22 recognizes that the reduction processing of the document image should be executed from the analysis result of the processing flow. Since the image processing device 30 takes charge of the reduction of the document image, (j) the flow controller 22 generates a processing request for instructing the reduction processing, and transmits the processing request to the image processing device 30. The processing request includes the compressed image data stored in the above-described processing (b) as data of the processing target image. Also, the processing request includes information of a reduction ratio as a parameter for the reduction processing.

(k) The image processing device 30 receives the processing request, and causes the decompressing unit 32 to decompress the compressed image included in the processing request. (l) Then, the processor 34 that takes charge of the reduction processing reduces the size of the image of the decompression result, (m) the compressing unit 36 compresses the image of the reduction result, and returns the processing result information including the compressed image to the processing control device 20.

(o) The processing control device 20 receives the processing result information. (p) The flow controller 22 recognizes that unit processing to be executed next on the processing result of the reduction processing in the processing flow is processing of filing the reduced image in the processing control device 20 (processing (q), described later), and (p) causes the decompressing unit 26 to decompress the compressed image obtained from the processing result information for the filing processing. (q) Then, the document name recognized in the barcode recognition processing in the above-described processing (i) is applied to the image of the decompression result (the reduced image of the document image) as a file name, and the image is filed in the storage device 10.

As shown in FIG. 2, in this system, the image that is exchanged between the processing control device 20 and the image processing device 30 is compressed, to avoid insufficiency of the communication band of the communication path (bus, network, etc.) therebetween. If the image to be exchanged is a continuous-tone image, lossy compression such as JPEG is used to obtain a high compression ratio. In case of using the lossy compression, if compression and decompression are repeated many times in a processing flow, an image may be deteriorated although it is not shown in the example in FIG. 2.

Although it is not shown in the example in FIG. 2, for example, a processing flow may be employed in which the image processing device 30 executes first image processing on an input image, and the image processing device 30 executes second image processing on the result of the first image processing. In this processing flow, first lossy compression is executed on an input image when the input image is transmitted from the processing control device 20 to the image processing device 30, and second lossy compression is executed on the result of the first image processing on the input image when the result is returned from the image processing device 30 to the processing control device 20. When the processing control device 20 requests for the second image processing, compressed data of the result of the first image processing received from the image processing device 30 may be merely directly transmitted to the image processing device 30. Hence, new lossy compression does not have to be executed. However, when the result of the second image processing is returned from the image processing device 30 to the processing control device 20, third lossy compression is executed. As described above, in the processing flow that successively executes the image processing many times, the lossy compression is repeated many times, and an image deterioration may be markedly generated.

In the above example, since the image processing device 30 executes both the first image processing and the second image processing being continuous in the processing flow, the result of the first image processing does not have to be returned to the processing control device 20. However, in case of a processing flow in which another image processing is executed on the result of the first image processing by software processing by the processing control device 20 and the second image processing is executed on the result of the image processing by the image processing device 30, the result of the first image processing has to be returned to the processing control device 20. In this case, the lossy compression is also executed even when the image of the target of the second image processing is transmitted from the processing control device 20 to the image processing device 30, the number of times of the lossy compression becomes larger than the above-described lossy compression.

Also, when the image processing device 30 may not include a processor for analyzing data of a processing instruction that defines a processing flow, or even when the image processing device 30 includes a processor for control, the performance of the processor may be limited. Hence, even if image processing is continued in the image processing device 30, it is impossible or difficult to cause the image processing device 30 to execute a flow of continuous plural units of image processing. For example, it is almost impossible to cause the image processing device 30 to execute a flow including branching and merging. Owing to this, in this system, the processing control device 20 collectively executes the control of the processing flow, and the image processing device 30 executes simple processing of receiving and executes requests of unit processing one by one from the processing control device 20 and returning the processing result to the processing control device 20. In such a system, exchange of an image is repeated between the processing control device 20 and the image processing device 30, and hence, image deterioration may occur due to the repetition of lossy compression.

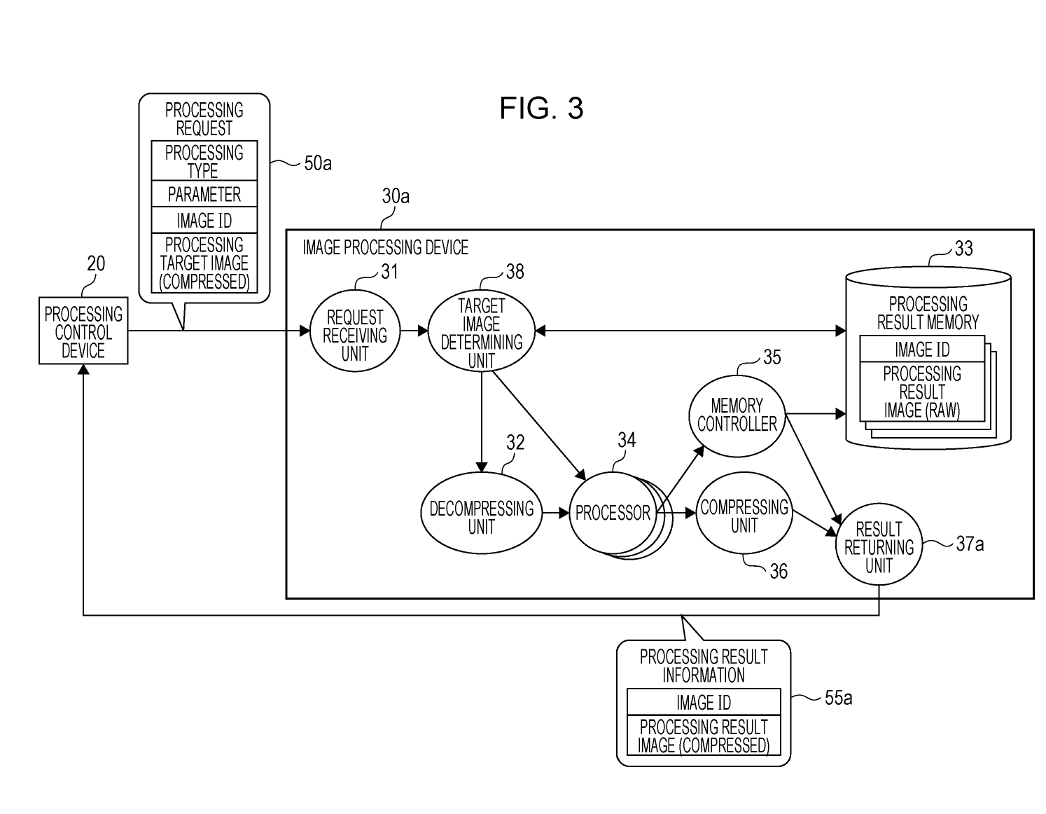

To reduce the image deterioration due to the repetition of the lossy compression, in this exemplary embodiment, as shown in FIG. 3, a processing result memory 33 that stores a raw image of a result of image processing executed by the processor 34 of an image processing device 30a is provided. Then, image processing is executed by using a corresponding raw image stored in the processing result memory 33, instead of a compressed processing target image included in a processing request 50a.

A system configuration of this exemplary embodiment is described below in further detail with reference to FIG. 3. The system configuration shown in FIG. 3 is obtained by particularly improving the image processing device 30 in the system configuration in FIG. 1. Regarding elements shown in FIG. 3, the same reference sign is applied to an element corresponding to the element in FIG. 1, and redundant description thereof is omitted. In FIG. 3, illustration of the storage device 10 is omitted.

The image processing device 30a exemplarily shown in FIG. 3 includes the processing result memory 33, a memory controller 35, and a target image determining unit 38 in addition to the group of elements included in the image processing device 30 in FIG. 1.

The processing result memory 33 uses a high-speed storage device such as a semiconductor random access memory, and functions as a storage place for storing raw images of processing results the group of processors 34.

The memory controller 35 provides control when a processing result image (raw image) generated by the processor 34 is stored in the processing result memory 33. For an example, the memory controller 35 causes all generated processing result images to be stored in the processing result memory 33. For another example, the memory controller 35 determines whether a generated processing result image is stored in the processing result memory 33 or not based on various conditions. In this exemplary embodiment, in either case, the memory controller 35 applies unique identification information to a processing result image to be stored in the processing result memory 33. The identification information is hereinafter referred to as image ID. If the image ID uses, for example, universally unique identifier (UUID), even if plural image processing devices 30 are present in a system, unique IDs may be applied without central management. UUID is merely an example. A processing result image is associated with an image ID and stored in the processing result memory 33. The applied image ID is arranged in processing result information 55a by a result returning unit 37a together with the compression result of the processing result image corresponding to the image ID, and the processing result information 55a is returned to the processing control device 20.

Also, the memory controller 35 deletes some processing result images stored in the processing result memory 33, and hence provides control of increasing the free space in the processing result memory 33. The control of the memory controller 35 is described later in detail. In this case, description is given according to an example, in which all generated processing result images are stored, and an example, in which a generated processing result image is determined to be stored or not, is described later.

The target image determining unit 38 determines whether or not an image of a processing target indicated by the processing request 50a from the processing control device 20 is stored in the processing result memory 33. In this example, the determination is made by using an image ID included in the processing request 50a. The mechanism of the determination is described below.

If the processing control device 20 (in particular, the flow controller 22) further requests image processing on the processing result image received from the image processing device 30a in response to the previous processing request, the processing control device 20 transmits the processing result image (after compression) and also the processing request 50a including the image ID received with the processing result image (both being included in the processing result information 55a) to the image processing device 30a. The image ID indicates the raw processing result image generated in the past and stored in the processing result memory 33. The target image determining unit 38 checks the stored content of the processing result memory 33 and determines whether or not a processing result image corresponding to the image ID included in the processing request 50a is stored in the processing result memory 33. The processing result image (raw image) corresponding to the image ID is expected to be generated in the past and stored once in the processing result memory 33. However, the processing result image may be thereafter possibly deleted because of insufficiency in free space of the processing result memory 33. If the processing result image is deleted, the processing result image corresponding to the image ID in the processing request 50a is not present in the processing result memory 33.

If the target image determining unit 38 finds the raw processing result image (raw) corresponding to the image ID included in the processing request 50a from the processing result memory 33, the target image determining unit 38 gives the raw processing result image to the processor 34 to cause the processor 34 to execute processing. The processor 34 that receives the raw processing result image corresponds to the processing type designated in the processing request 50a. Also, if the image ID is not included in the processing request 50a, or if the raw processing result image (raw) corresponding to the image ID included in the processing request 50a is not present in the processing result memory 33, the target image determining unit 38 causes the decompressing unit 32 to decompress the compressed image of the processing target in the processing request 50a, and causes the processor 34 corresponding to the designated processing type to process the image of the decompression result.

The processing request 50a not including the image ID may be generated when the processing control device 20 requests first image processing in a processing flow. Also, the processing request 50a not including an image ID may be generated when the processing control device 20 executes image processing on the processing result image returned from the image processing device 30 and requests image processing on the image of this image processing result.

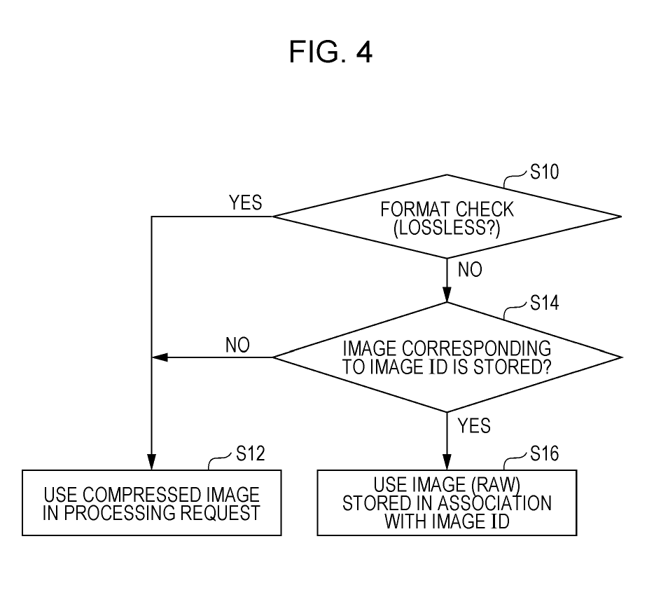

Next, an example of a processing procedure that is executed by the target image determining unit 38 is described with reference to FIG. 4. In this procedure, when the image processing device 30 (in particular, the compressing unit 36) compresses the processing result image, it is expected to select and use one of a lossless compression method and a lossy compression method in accordance with the processing result image.

For example, if image processing to be executed by the image processing device 30 is binarization processing, the processing result image is a binary image. In case of the binary image, a compression method such as run-length compression suitable for a binary image is used instead of a compression method such as JPEG suitable for a continuous-tone image. The method such as run-length compression is a lossless compression method. Since an image is not deteriorated even if lossless compression is executed on a raw processing result image, a raw processing result image without deterioration in image before compression is not required to be stored in the processing result memory 33. That is, when the processing result image after the lossless compression by the compressing unit 36 is returned to the processing control device 20 and another image processing is executed on the processing result image, the processing request 50a including the processing result image after the lossless compression as a processing target image is transmitted from the processing control device 20 to the image processing device 30. In this case, the image processing device 30 decompresses the processing target image applied with the lossless compression and included in the processing request 50a, and hence a raw image without deterioration, which is the processing result of the previous image processing before the current image processing is obtained. Hence, for an example, the processing result image on which lossless compression is executed by the compressing unit 36 is not stored in the processing result memory 33 because the limited memory space does not have to be consumed. Whether the compression executed on the processing result image by the compressing unit 36 is lossless compression or lossy compression may be determined on the basis of the type of image processing with which the processing result image is generated.

In the procedure in FIG. 4, the target image determining unit 38 checks format information of the compressed image of the processing target included in the received processing request 50a, and determines whether or not the compressed image is compressed by lossless compression (S10). That is, if the information of the compression method included in the format information indicates a compression method corresponding to lossless compression, it is determined that the compressed image is compressed by lossless compression. If not, it is determined that the compressed image is compressed by lossy compression.

If the compression is determined as lossless compression in S10, the target image determining unit 38 determines that the compressed image (image after lossless compression) in the processing request 50a is used as the target of image processing indicated by the processing request 50a, and gives the compressed image to the decompressing unit 32 (S12). Accordingly, the compressed image is decompressed by lossless decompression, and the image of the decompression result is processed by the processor 34 corresponding to the processing type in the processing request 50a.

In contrast, if the compression is determined as lossy compression in S10, the target image determining unit 38 determines the raw processing result image corresponding to the image ID in the processing request 50a, as a first candidate, for a target of image processing. Then, it is checked whether or not the processing result image (raw) corresponding to the image ID is stored in the processing result memory 33 (S14). If the image ID is not included in the processing request 50a or the processing result image corresponding to the image ID in the processing request 50a is already deleted, the determination result in S14 becomes NO, the target image determining unit 38 gives the compressed image in the processing request 50a to the decompressing unit 32, and causes the corresponding processor 34 to process the image of the decompression result output from the decompressing unit 32 accordingly (S12).

If the determination result in S14 is YES, the target image determining unit 38 causes the corresponding processor 34 to process the processing result image (raw image) corresponding to the image ID in the processing result memory 33 (S16).

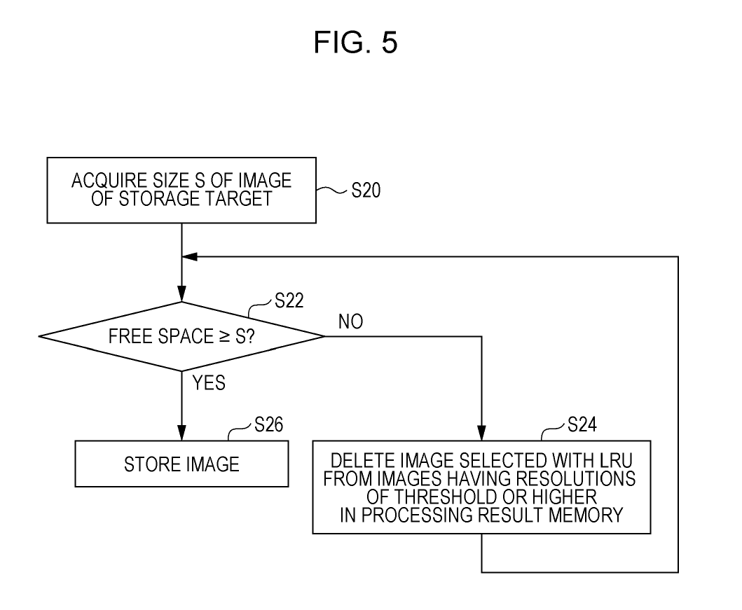

When the processing result image generated by the processor 34 is stored in the processing result memory 33, the free space may be occasionally insufficient. In this case, the memory controller 35 deletes some processing result images stored in the processing result memory 33 to ensure the required free space. A method of selecting a processing result image to be deleted may directly use a general algorithm such as last recently used (LRU). Also, another example may use a selection method regarding deterioration of an image. An example of this method is shown in FIG. 5.

In a procedure in FIG. 5, when the processing result image output from the processor 34 is to be stored, the memory controller 35 acquires information of a size S of the image (S20). Then, it is determined whether or not the free space of the processing result memory 33 is sufficient for housing the image with the size S (S22). If the determination is “insufficient” in S22 (determination result is NO), the memory controller 35 selects only images having resolutions equal to or higher than a predetermined threshold from processing result images in the processing result memory 33, and selects an image to be deleted with an existing delete target selection algorithm such as LRU from the selected processing result images (S24). That is, in S24, processing result images with resolutions lower than the threshold are not selected as a delete target. This is because an image with a lower resolution is more deteriorated by lossy compression, and hence there is a merit of keeping a raw image for later use.

Alternatively, in S24, instead of a simple division into two ways with use of a single threshold, determination may be made such that an image with a lower resolution is more hardly selected as a delete target stepwise or continuously. The determination processing in S24 exemplarily shown in FIG. 5, in which an image with a resolution lower than the threshold is never selected as a delete target is not “stepwise or continuous,” however, corresponds to “determination in which an image with a lower resolution is more hardly selected as a delete target.”

After the image selected in S24 is deleted from the processing result memory 33, the free space of the processing result memory 33 is determined in S22 again. The processing in S22 and S24 is repeated until the free space of the processing result memory 33 becomes equal to or larger than the size S of the processing target image to be stored. Then, if it is determined that the free space of the processing result memory 33 becomes equal to or larger than the size S of the processing target image to be stored in S22, the memory controller 35 stores the processing result image in the processing result memory 33 in association with the image ID applied to the processing result image (S26).

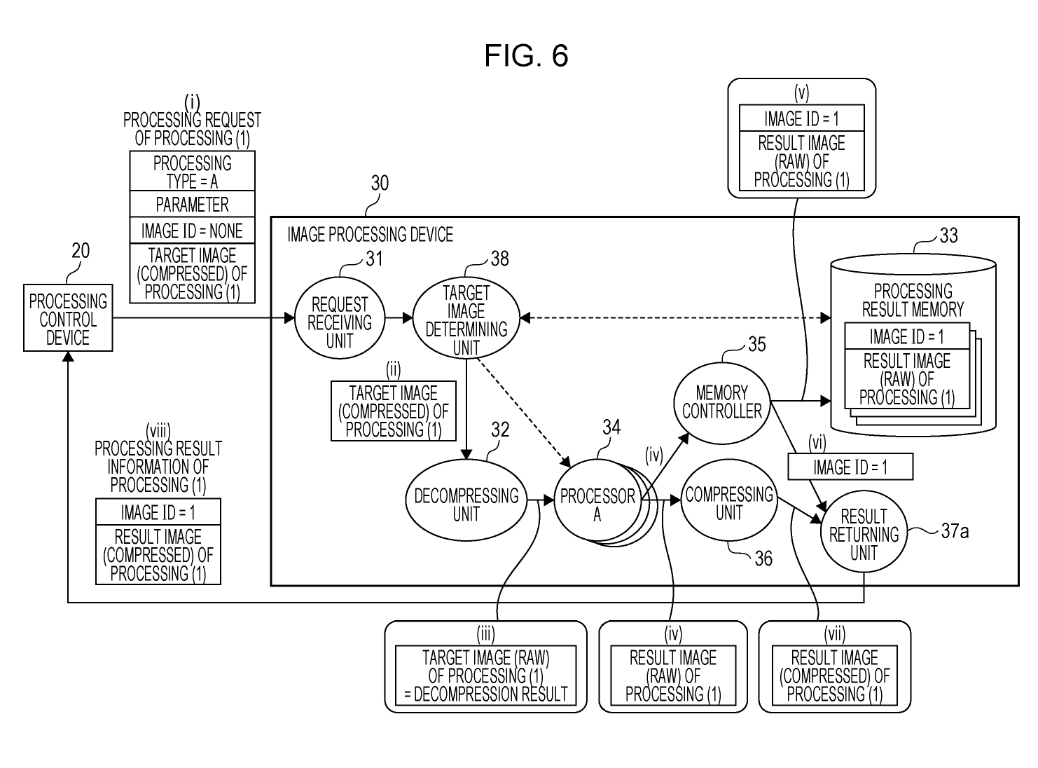

Next, a state in which the system exemplarily shown in FIG. 3 executes the processing flow is described with reference to specific examples shown in FIGS. 6 to 8.

FIG. 6 shows a state in which first processing (processing (1)) in the processing flow is executed. In this case, (i) the processing control device 20 transmits a processing request of processing (1) to the image processing device 30 first. In this example, it is assumed that the type of the processing (1) is “A” (for example, skew correction). Also, in this case, the processing request includes compressed data of an image designated as a processing target of the processing (1) in the processing flow. Since the processing (1) is the first processing in the processing flow, the image of the processing target is not present in the processing result memory 33 of the image processing device 30. Hence, the value of the image ID in the processing request is “none” (value indicative of that the image ID is not present). Since the value of the image ID in the processing request is “none,” the target image determining unit 38 of the image processing device 30 that receives the processing request causes the decompressing unit 32 to decompress (ii) a compressed processing target image included in the processing request. (iii) The decompressing unit 32 decompresses the compressed image with a corresponding decompression algorithm, and inputs a raw image data obtained as the result of the decompression as a processing target image to the processor 34 corresponding to the processing type “A” in the processing request. The processor 34 executes image processing on the processing target image. (iv) The processing result image obtained as the result of the image processing is given to the compressing unit 36 and the memory controller 35. (v) The memory controller 35 applies a unique image ID “1” to the processing result image (raw image), and stores the processing result image in the processing result memory 33 in association with the image ID “1.” (vi) Also, the memory controller 35 gives the image ID “1” to the result returning unit 37a. (vii) The processing result image is compressed by the compressing unit 36, and a compressed image obtained as the result of the compression is given to the result returning unit 37a. (viii) The result returning unit 37a returns processing result information including the received image ID “1” and the compressed image, as the processing result of the processing (1), to the processing control device 20.

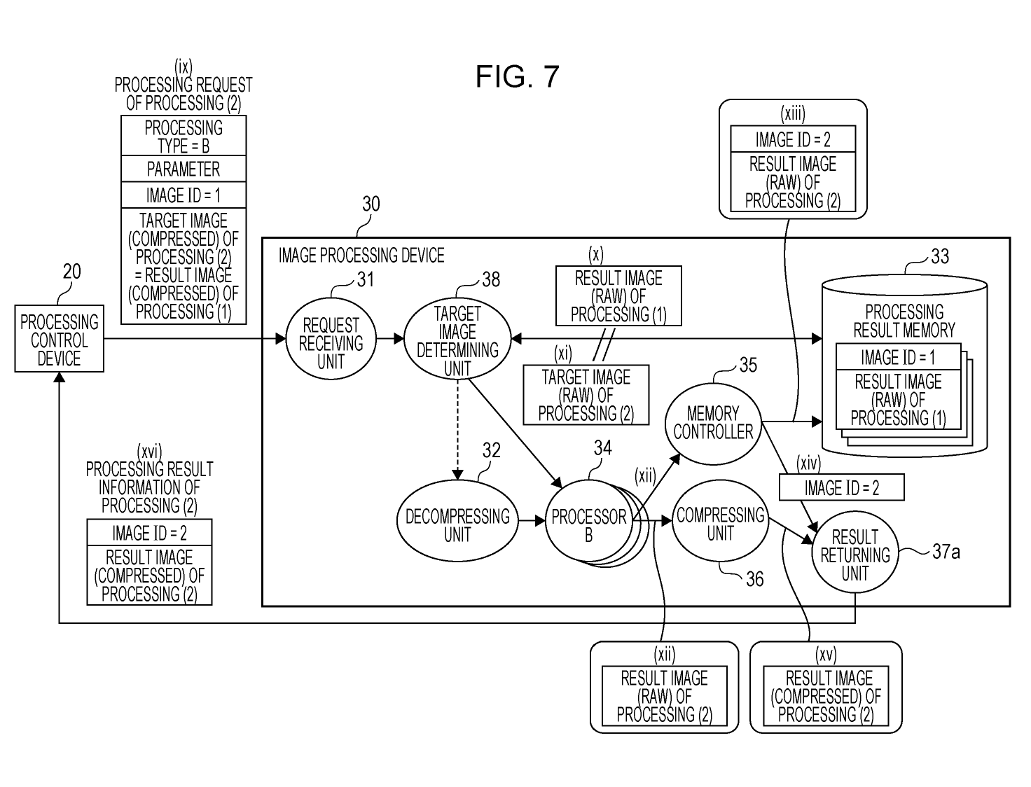

FIG. 7 shows a state in which second processing (processing (2)) in the processing flow is executed. In this case, it is assumed that the processing (2) is image processing on the processing result image of the processing (1) as a target. Also, it is assumed that the type of the processing (2) is “B.” In this case, the processing control device 20 sends (ix) a processing request including the image ID “1” and the compressed image included in the received processing result information of the processing (1), as information indicative of the processing target image, to the image processing device 30. The target image determining unit 38 of the image processing device 30 that receives the processing request checks whether or not a processing result image corresponding to the image ID “1” in the processing request is stored in the processing result memory 33. In this example, it is assumed that the processing result image corresponding to the image ID “1” is still stored. In this case, the target image determining unit 38 supplies (x) the processing result image, that is, the processing result image generated in the processing (1) in FIG. 6, as (xi) the processing target image of the current processing (2), to the processor 34 corresponding to the processing type “B.” The subsequent processing (xii) to (xvi) are similar to the processing (iv) to (viii) in FIG. 6, and hence the description is omitted.

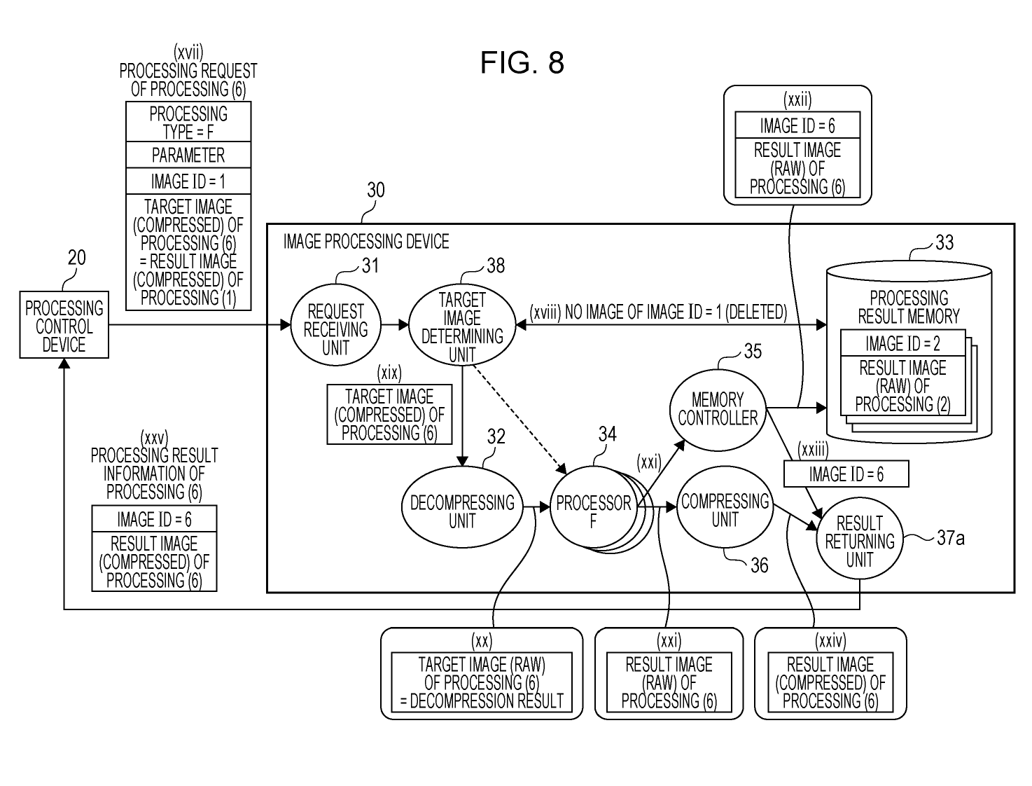

FIG. 8 shows a state in which sixth processing (processing (6)) in the processing flow is executed. In this case, the processing (6) is image processing whose target is the processing result image of the processing (1). However, it is assumed that the image of the processing result of the processing (1) is already deleted from the processing result memory 33. In this case, the processing control device 20 sends (xvii) a processing request including the image ID “1” and the compressed image received as the processing result of the processing (1) in (viii) in FIG. 6, as information indicative of the processing target image, to the image processing device 30. The target image determining unit 38 of the image processing device 30 that receives the processing request checks whether or not a processing result image corresponding to the image ID “1” in the processing request is stored in the processing result memory 33. (xviii) In this example, the processing result image corresponding to the image ID “1” is not present in the processing result memory 33. Hence, the target image determining unit 38 causes the decompressing unit 32 to decompress (xix) the compressed processing target image included in the processing request. The subsequent processing (xx) to (xxv) are similar to the processing (iii) to (viii) in FIG. 6, and hence the description is omitted.

An exemplary embodiment of the invention has been described above.

Next, a first modification is described. In the above-described exemplary embodiment, the memory controller 35 applies an image ID to a processing result image stored in the processing result memory 33. In the first modification, instead of application of an image ID, a compressed image corresponding to the processing result image is used instead of an image ID. That is, the memory controller 35 stores a compressed image, which is the result of the compression of the processing target image by the compressing unit 36, in the processing result memory 33, in association with a processing target image (raw) to be stored. Since the compressed image functions as an image ID, the processing result information returned by the result returning unit 37a does not include an image ID in addition to the compressed image. Also, in this modification, the processing control device 20 transmits the processing request 50 not including an image ID to the image processing device 30 similarly to the example in FIG. 1. The image processing device 30 checks whether or not the same compressed image as the compressed image included in the processing request 50 is present in the processing result memory 33. If the compressed image is preset, the image processing device 30 causes the corresponding processor 34 to process the raw processing result image stored in the processing result memory 33 in association with the compressed image, as a processing target of the processing request. It may be determined whether the compressed image included in the processing request 50 and the compressed image in the processing result memory 33 are “the same,” for example, by comparing binary data of image data part excluding a header etc. of the compressed image included in the processing request 50 with that of the compressed image in the processing result memory 33.

As described above, since the compressed image is used as the image ID, the image ID (which may be provided in addition to the compressed image) is no longer required to be included in the processing request or the processing result information.

In this modification, the compressed image to be stored as the image ID in the processing result memory 33 may not be the entire compressed image data obtained by compressing the processing result image by the compressing unit 36. Predetermined part of the compressed image data (for example, part with a predetermined data amount at the beginning) may be stored as an image ID. In this case, the memory controller 35 extracts the predetermined part from the compressed image included in the processing request 50, and checks whether or not an image ID (part of compressed image data) that meets the extracted data is present in the processing result memory 33.

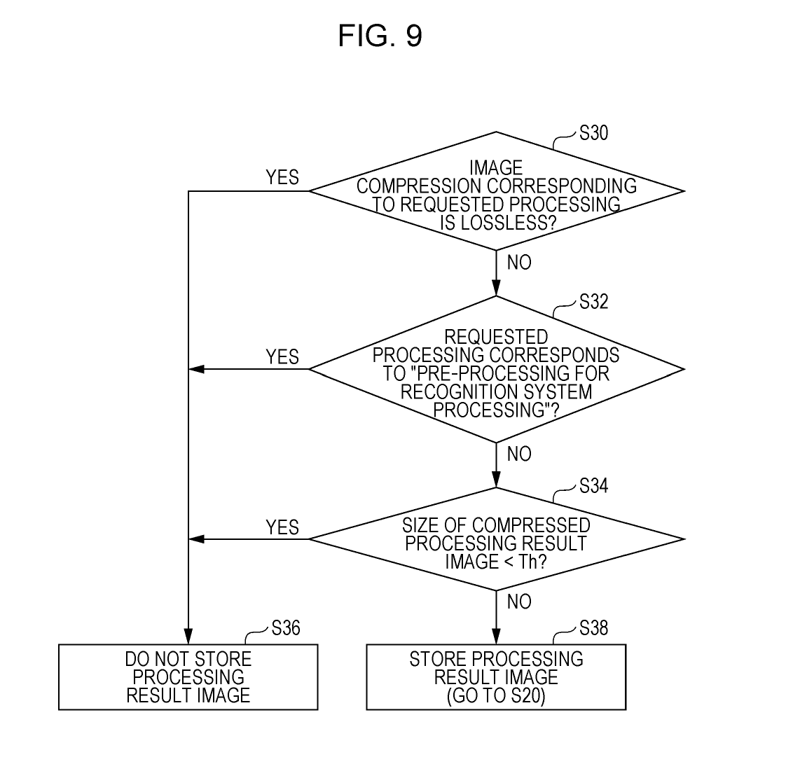

Next, a second modification is described with reference to FIG. 9.

In the above-described exemplary embodiment, the memory controller 35 stores all data in the processing result memory 33 other than an image that is compressed by lossless compression by the compressing unit 36 from among processing result images generated by the processor 34. In contrast, in this second modification, processing result images to be stored in the processing result memory 33 are further narrowed with regard to other condition. FIG. 9 shows an example of a procedure that is executed by the memory controller 35 in this second modification.

In the procedure in FIG. 9, it is determined whether a compression method corresponding to image processing requested from the processing control device 20 is lossless compression or not (S30) similarly to the above-described exemplary embodiment. For example, if the processing request requests “binarization,” the determination result of S30 becomes YES (“lossless”). In this case, the processing result image of the image processing is not stored in the processing result memory 33 (S36).

Also, the memory controller 35 determines whether or not the requested image processing corresponds to predetermined “pre-processing for recognition system processing” (S32). In this case, “the recognition system processing” is processing of recognizing the content of part or the entirety of an image such as barcode recognition or optical character recognition (OCR). Also, “the pre-processing for the recognition system processing” is image processing serving as pre-processing to be executed to improve recognition accuracy etc. on a target image of the recognition system processing. For example, “the pre-processing for the recognition system processing” is binarization processing for barcode that is executed on a target image of barcode recognition. The processing result image obtained by “the pre-processing for the recognition system processing” is returned to the processing control device 20, and then is subjected to the recognition system processing (for example, barcode recognition) corresponding to the pre-processing. As described above, the processing result image of the pre-processing for the recognition system processing is typically subjected to the recognition system processing in the processing control device 20. The processing result image does not usually serve as a processing target of another image processing that is executed in the image processing device 30. Accordingly, the processing result of the pre-processing for the recognition system processing is not required to be stored in the processing result memory 33. Based on such an idea, if the determination result in S32 is YES, the processing result image is not stored in the processing result memory 33 (S36).

Image processing corresponding to “the pre-processing for the recognition system processing” may be previously set in the image processing device 30.

Here, “the pre-processing for the recognition system processing” is described as an example, even in case of image processing of other type, if the processing result image of the image processing is not expected to be subjected to another image processing in the image processing device 30, the processing result image of the image processing is not required to be stored. Hence, for image processing that is previously set as the image processing of such a type, the processing result image may not be stored in the processing result memory 33.

Also, the memory controller 35 determines whether or not the data size of the compression result by the compressing unit 36 of the processing result image generated by the processor 34 is smaller than a predetermined threshold Th. The threshold Th is a threshold for determining whether or not the processing result image is substantially blank (blank sheet). The processing result image being substantially blank may be possibly deleted as being unnecessary in the processing control device 20. Also, if the image is substantially blank, there is no large difference between a raw image before compression and an image obtained by compressing the raw image by lossy compression and then decompressing the image. Therefore, the processing result image being substantially blank is not stored in the processing result memory 33. If the processing result image is substantially blank, the data amount of the compression result becomes very small. In the procedure in FIG. 9, if the size of the compressed image is smaller than the threshold Th, the original processing result image is determined as being substantially blank in S34, and the processing result image is not stored in the processing result memory 33 (S36). The threshold Th may be determined on the basis of the data amount of compressed data when an image that seems to be substantially blank is compressed.

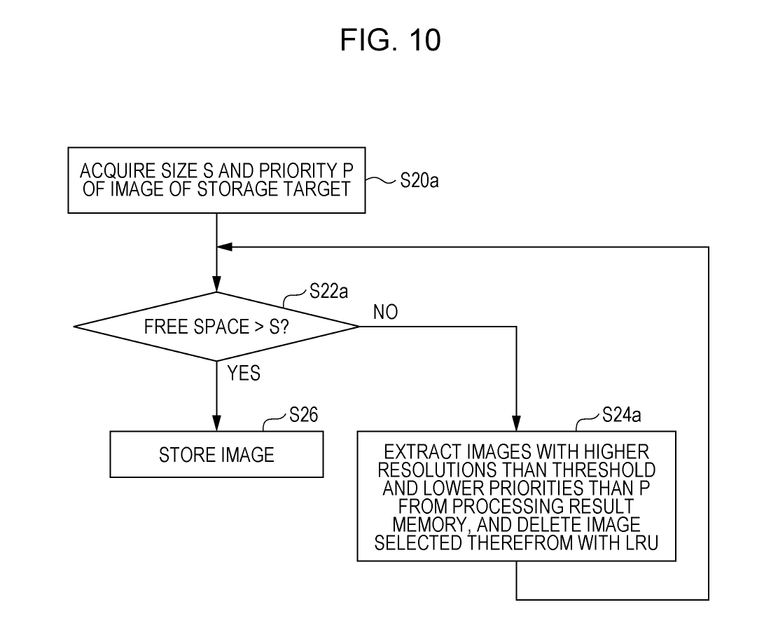

If all the results of the inspections in S30, S32, and S34 are NO, that is, if the compression method corresponding to the processing result image is lossy compression, if the type of the executed image processing is not “the pre-processing for the recognition system processing,” and if the size of the compressed data of the processing result image is equal to or larger than the threshold Th, determination is made such that the processing result image is stored (S38). In this case, the processing goes to the processing in FIG. 5 (or in FIG. 10, described later), and the processing result image is stored in the processing result memory 33.

It is to be noted that S30, S32, and S34 do not have to be executed in the illustrated order. The inspections may be executed in any order as long as determination is made such that the processing result image is not stored if any of the three inspections obtains YES determination.

Alternatively, in the processing in FIG. 9, if the processing that is executed by the image processing device 30 is “the pre-processing for the recognition system processing,” a raw image of the processing target image obtained by decompressing the compressed image in the processing request that requests the processing by the decompressing unit 32 may be stored in the image processing device 30. This is because the image being the target of “the pre-processing for the recognition system processing” becomes a target of another image processing with high possibility. For example, in a processing flow of recognizing a barcode from an image of a scanned document, correcting skew of the image, and filing the corrected image in association with a bibliographic content recognized from the barcode, the image being the processing target of the barcode recognition becomes the target of the skew correction later. In this case, as long as the processing result image after decompression obtained at “the pre-processing for the recognition system processing” is stored, when the later processing is executed on the same image, the compressed image does not have to be decompressed again at the later processing by using the stored processing result image.

Next, a modification of the processing of the memory controller 35 is described with reference to FIG. 10. In FIG. 10, the same reference sign is applied to a step similar to the step in the procedure in FIG. 5.

In the procedure in FIG. 10, processing result images of plural jobs are expected to be stored in a processing result, and a processing result image to be deleted from the processing result memory 33 is selected with regard to the priority of the job to which the processing result image belongs. In this case, the “job” is a single processing flow defined by a processing instruction. In this example, it is assumed that each job has set therein own priority. The method of setting the priority is not particularly limited. For example, a user who instructs a job may set the priority, or the priority may be automatically set under a rule previously determined in accordance with the type etc. of the job.

In this modification, the priority of the job to which the processing result image to be stored in the processing result memory 33 belongs is compared with the priority of each processing result image stored in the processing result memory 33 (or priority of the job to which the processing result image belongs). The delete target is determined also with regard to the comparison result.

That is, in the procedure in FIG. 10, when the processing result image output from the processor 34 is to be stored, the memory controller 35 acquires information of a size S of the image and a priority P of the job to which the processing result image belongs (S20a). In this example, the processing control device 20 causes the information of the identification information and priority of the job to be included in the processing request 50, 50a that is transmitted to the image processing device 30. The memory controller 35 may acquire the information of the priority of the job from the processing request. Then, it is determined whether or not the free space of the processing result memory 33 is sufficient for housing the image with the size S (S22a), and if the determination is “insufficient,” the processing goes to step S24a. In S24a, the memory controller 35 extracts images having resolutions higher than a predetermined threshold and having priorities lower than the priority P acquired in S20a from processing result images in the processing result memory 33. Then, from the extracted processing result images, an image to be deleted is selected with an existing delete target selection algorithm such as LRU.

The procedure in FIG. 10 may be similar to the procedure in FIG. 5 except for S20a and S24a. However, when the processing result image is stored in S26, the priority of the job to which the processing result image belongs is also stored. The priority is one acquired in S20a from the processing request for instructing the generation of the processing result image.

The above-described exemplary embodiment and modifications may be applied to a system including plural image processing devices 30.

The exemplarily described processing control device 20 and image processing device 30 may be each provided, for example, by causing a general-purpose computer to execute a program that expresses processing of respective functional modules of the devices. A computer mentioned herein has as hardware, for example, a circuit configuration in which a microprocessor such as a CPU, memories (first memories) such as a random access memory (RAM) and a read-only memory (ROM), a hard disk drive (HDD) and a solid-state drive (SSD), a second memory controller that controls a second memory such as a flash memory, various input/output (I/O) interfaces, and a network interface that provides control for connection with a network in a wired or wireless manner are connected through, for example, a bus. Also, a disk drive for reading from and/or writing in a portable disk recording medium such as a compact disc (CD), a digital versatile disc (DVD), or a Blu-ray Disc; a memory reader/writer for reading from and/or writing in a portable non-volatile recording medium complying with any of various standards such as a flash memory; or the like; may be connected to the bus, for example, through the I/O interface. The program having described therein the content of processing of the respective above-exemplified functional modules is stored in a second memory such as a flash memory through a recording medium such as a CD or a DVD, or a communication measure such as a network, and is installed in a computer. The program stored in the second memory is read to the RAM, and is executed by the microprocessor such as the CPU. Accordingly, the above-exemplified functional module group is provided. Also, part of the functions of the processing control device 20 and the image processing device 30, for example, some types of image processing may be provided as a hardware circuit (including reconfiguration by FPGA or the like), and may be combined with the control function provided by the program.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
a processing control device; and
an image processing device,
wherein the processing control device includes
a request transmitting unit that, in accordance with a processing procedure including at least one image processing, transmits a processing request for requesting execution of each image processing in the processing procedure, to the image processing device, and
a result receiving unit that receives processing result information including identification information of an image of a processing result corresponding to the processing request and a compressed image obtained by compressing the image of the processing result, from the image processing device,
wherein, if the request transmitting unit requests second image processing on an image of a processing result of first image processing in the processing procedure, the request transmitting unit transmits a processing request including information for specifying the second image processing, as well as identification information and a compressed image included in processing result information received by the result receiving unit from the image processing device in response to a processing request of the first image processing, to the image processing device, and
wherein the image processing device includes
a decompressing unit that decompresses a compressed image,
a request receiving unit that receives a processing request from the processing control device,
an executing unit that generates an image of a processing result by executing image processing specified in the processing request on an image corresponding to identification information included in the processing request received by the request receiving unit,
a processing result memory that stores the image of the processing result in association with identification information of the image of the processing result,
a compressing unit that generates a compressed image of the processing result by executing compression processing on the image of the processing result,
a result returning unit that returns processing result information including the identification information of the image of the processing result and the compressed image of the processing result, to the processing control device, and
an execution controller that determines whether or not an image associated with the identification information included in the processing request received from the processing control device is stored in the processing result memory, and causes the executing unit to execute image processing on the image stored in the processing result memory if the image is stored, or on an image obtained by causing the decompressing unit to decompress a compressed image included in the processing request if the image is not stored.

2. The image processing system according to claim 1,
wherein the processing result memory stores the compressed image of the image of the processing result as the identification information of the image of the processing result in association with the image of the processing result, and
wherein part or entirety of the compressed image included in the processing request is used as the identification information corresponding to the image before the compression of the compressed image, and the processing request does not include identification information of the image in addition to the part or the entirety of the compressed image.

3. The image processing system according to claim 1,
wherein the image processing device further includes a memory controller that provides control whether or not the image of the processing result generated by the executing unit is stored in the processing result memory, and
wherein the memory controller provides control so that the image of the processing result is not stored in the processing result memory if the compression processing to be executed on the image of the processing result by the compressing unit is lossless compression, and the image of the processing result is stored in the processing result memory if the compression processing to be executed on the image of the processing result by the compressing unit is lossy compression.

4. The image processing system according to claim 1, wherein the memory controller provides control so that the image of the processing result is not stored in the processing result memory if a type of the image processing to be executed by the executing unit for generating the image of the processing result is a predetermined type of image processing which is expected not to be executed by the image processing device later on the image of the processing result.

5. The image processing system according to claim 4, wherein the memory controller provides control so that an image which is an original of the image of the processing result is stored in the processing result memory if the type of the image processing to be executed by the executing unit for generating the image of the processing result is the predetermined type of the image processing which is expected not to be executed by the image processing device later on the image of the processing result.

6. The image processing system according to claim 3, wherein the memory controller provides control so that the image of the processing result before the compression of the compressed image is not stored in the processing result memory if a data amount of the compressed image of the processing result is equal to or smaller than a predetermined threshold for identifying a blank sheet.

7. The image processing system according to claim 1, further comprising a unit that increases a free space of the processing result memory by deleting an image stored in the processing result memory and that provides control so that an image with a lower resolution is more hardly selected as a delete target from images stored in the processing result memory.

8. A processing control device comprising:
a request transmitting unit that, in accordance with a processing procedure including at least one image processing, transmits a processing request for requesting execution of each image processing in the processing procedure, to an image processing device; and
a result receiving unit that receives processing result information including identification information of an image of a processing result corresponding to the processing request and a compressed image obtained by compressing the image of the processing result, from the image processing device,
wherein, if the request transmitting unit requests second image processing on an image of a processing result of first image processing in the processing procedure, the request transmitting unit transmits a processing request including information for specifying the second image processing, as well as identification information and a compressed image included in processing result information received by the result receiving unit from the image processing device in response to a processing request of the first image processing, to the image processing device.

9. An image processing device comprising:
a request receiving unit that receives a processing request from a processing control device, and that receives, as a processing request for requesting second image processing on an image of a processing result of first image processing in a processing procedure including at least one image processing, a processing request including information for specifying the second image processing, as well as identification information and a compressed image included in processing result information received by a result receiving unit from the image processing device in response to a processing request of the first image processing;
a processing result memory that stores an image of a processing result obtained when an executing unit executes image processing specified in the processing request on an image corresponding to the identification information included in the processing request received by the request receiving unit, in association with identification information of the image of the processing result;
a result returning unit that returns processing result information including the identification information of the image of the processing result and a compressed image of the processing result obtained by executing compression processing on the image of the processing result, to the processing control device; and
an execution controller that determines whether or not an image associated with the identification information included in the processing request received from the processing control device is stored in the processing result memory, and causes the executing unit to execute image processing on the image stored in the processing result memory if the image is stored, or on an image obtained by causing a decompressing unit to decompress a compressed image included in the processing request if the image is not stored.
